(19) United States
(12) Patent Application Publication
(10) Pub. No.: US 2013/0020843 A1
(43) Pub. Date: Jan. 24, 2013

(54) Recyclable Seat and Refuse Container

(71) Applicants: Dustin Charles Rauch, Leesburg, VA (US); Gabriela Moraes Rauch, Leesburg, VA (US)

(72) Inventors: Dustin Charles Rauch, Leesburg, VA (US); Gabriela Moraes Rauch, Leesburg, VA (US)

(21) Appl. No.: 13/358,400

(22) Filed: Jan. 25, 2012

Related U.S. Application Data
(60) Provisional application No. 61/447,744, filed on Mar. 1, 2011.

(51) Int. Cl. A47C 7/00; B31D 5/00

(52) U.S. Cl. 297/188.01; 297/440.12; 29/426.1

(57) ABSTRACT

A disposable and portable seating apparatus made from a single sheet of recyclable material, such as corrugated cardboard. The apparatus is intended to be used as temporary seating for events, festivals, gatherings, or similar situations where seating is not readily available, or practical. The structural component of the seating apparatus is designed to interlock providing optimal strength to support the weight of an average adult. The design and material allow the seating apparatus to be assembled and disassembled relatively easily, without the use of any tools or additional bonding agents, such as glue, staples, or other adhesives. After use, the seat can be turned upside down and serve as a recycling container, or trash receptacle for discarded materials, such as; cans, bottles, etc. The exterior of the assembled may act as a medium for advertising purposes, used by companies promoting products, events, contests, teams, or organizations.

### CROSS-REFERENCE TO RELATED APPLICATIONS

This nonprovisional patent is related to Provisional Patent No. 61/447,744 filed Mar. 1, 2011 by Dustin Charles Rauch and Gabriela Moraes Rauch.

### BACKGROUND OF INVENTION

There are many circumstances where traditional seating for outdoor events and activities is not adequate or impractical. Such circumstances could be music concerts, marathons, or festivals, where attendance could be several thousands. The task and cost of bringing standard seating to these events would be practically impossible. Also, it is common for people attending these events to travel using public transportation or even walking long distances. Given this, a person in attendance may be reluctant to bring their own chair.

Currently, to our knowledge, there are no readily available recyclable seats available for consumers to purchase. At an outdoor event, it is common to see disposable silverware, drink coolers, and even grills, however seating is limited to conventional folding metal or fabric chairs. Also disposal of waste and recycling at these events has been limited to onsite trashcans, trash bags, or dumpsters. Combining a recycling bin or refuse container with a temporary seat, to our knowledge, has never existed.

In situations such as hunting and fishing, temporary seating would be highly sought after by occasional sportsmen who prefer not to invest a lot of money in seating when it will only be used infrequently. Also, the benefit of having a seat that could hold game birds or caught fish would be desirable.

Children would also benefit from a temporary chair, as the exterior would provide an acceptable medium to color. Good habits could be learned by teaching a child to only draw on appropriate items. The recycle bin section of the seat could be used to hold toys or games as well.

There are a wide range of uses for a temporary seat with designated storage space. Cardboard is an environmentally friendly substance as compared to plastics, as the time to degrade in a landfill is much less, and the process to recycle and reuse is easier. By being able to fold the seat completely flat before and after use, transportation and disposal become much simpler. The lack of bonding agents make the recyclable seat environmentally friendly and safe.

### SUMMARY

A single sheet of multi walled corrugated cardboard is cut using a rotary die cutter. The size of the seat is set by the demand of the customer; however the proportions are set to ensure consistency and safety when fully constructed. The seat may be folded in half along a diagonal score along the top inside of the seat. This creates a smaller size and allows for greater ease of use during transportation. Generally a single side of the die cut cardboard will be printed on with company information as well as possible advertising or other designs.

To assemble the recyclable seat and refuse container, the cut sheet of cardboard must lay flat with the creases and scores facing upwards. The two flaps on either side with gaps in the middle should be folded perpendicular to the adjacent connecting sides. The attached sides should fold along the crease joining the top of the seat and the larger side until they are perpendicular to the ground. The two previously folded, gapped sides should meet diagonally in the middle. This is the main support structure of the seat, as well as walls to the refuse container portion. The two unfolded sides should be folded along the designated crease perpendicular from the ground. The final unfolded sides should then be rotated upwards, to interlock the adjacent walls.

The resulting structure can be flipped right-side up and used as a seat. It can also be used upside down as a storage bin or refuse container.

To breakdown the structure, simply unfold the seat opposite from the steps used in assembly. It will return to its unformed shape and can be recycled or reused.

### DESCRIPTION

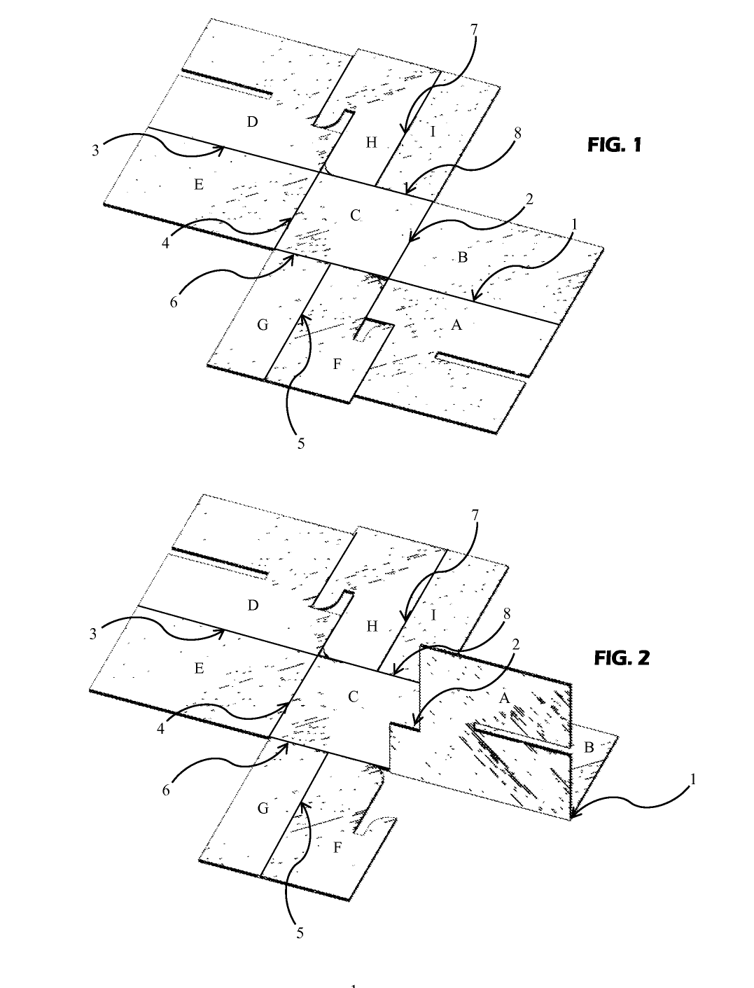

FIG. 1 is an isometric view of the disassembled form for the disposable seating apparatus.

FIG. 2 shows an isometric view of the first step in assembly: Component A folded perpendicular along Axis 1 to Component B.

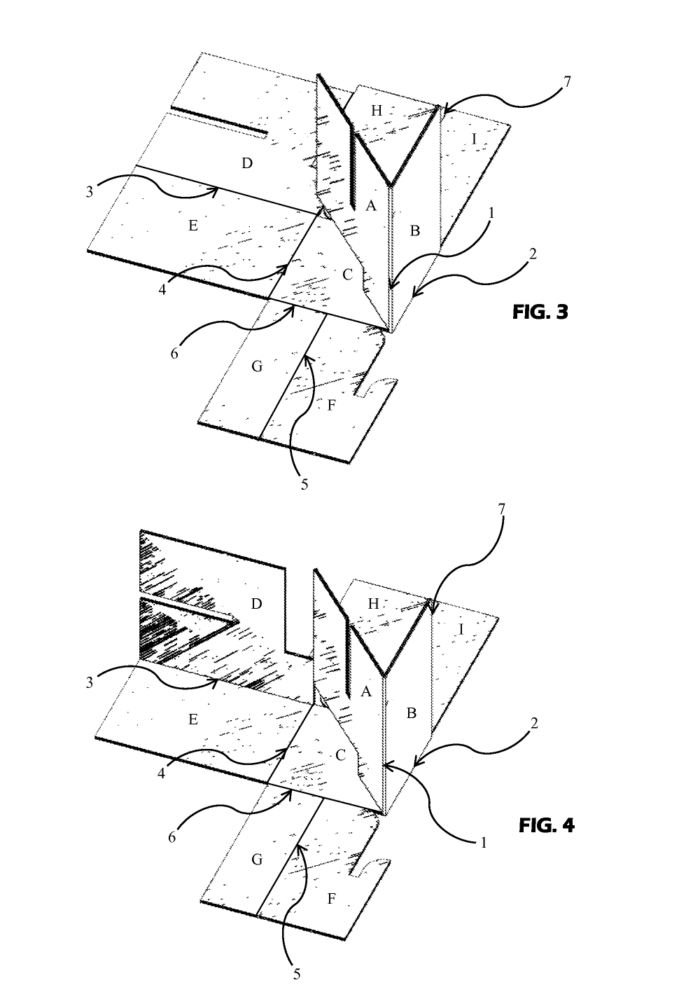

FIG. 3 shows an isometric view of the second step in assembly: Component B folded perpendicular along Axis 2 to Component C; Component A increases rotation along Axis 1 with a resulting angle of 45 degrees with Component B.

FIG. 4 shows an isometric view of the third step in assembly: Component D folded perpendicular along Axis 3 to Component E.

FIG. 5 shows an isometric view of the fourth step in assembly: Component E folded perpendicular along Axis 4 to Component C; Component D, now hidden from view, increases rotation along Axis 3 with a resulting angle of 45 degrees with Component E. Component D, hidden from view, aligns parallel to Component A, while both keeping 45 degree angles respective to their components using Axis 3 and Axis 1 respectively.

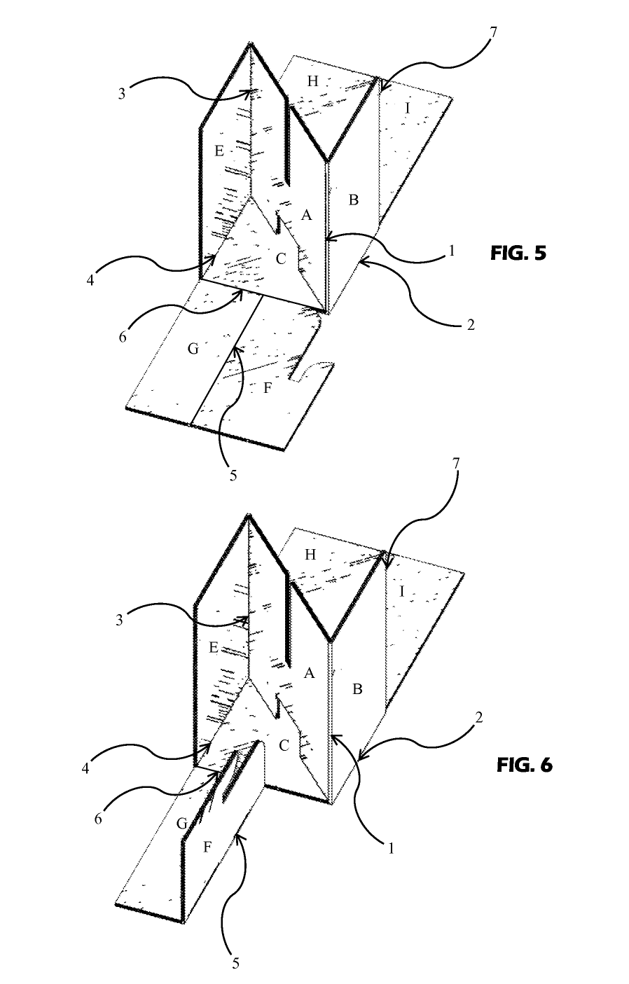

FIG. 6 shows an isometric view of the fifth step in assembly: Component F folded perpendicular along Axis 5 to Component G.

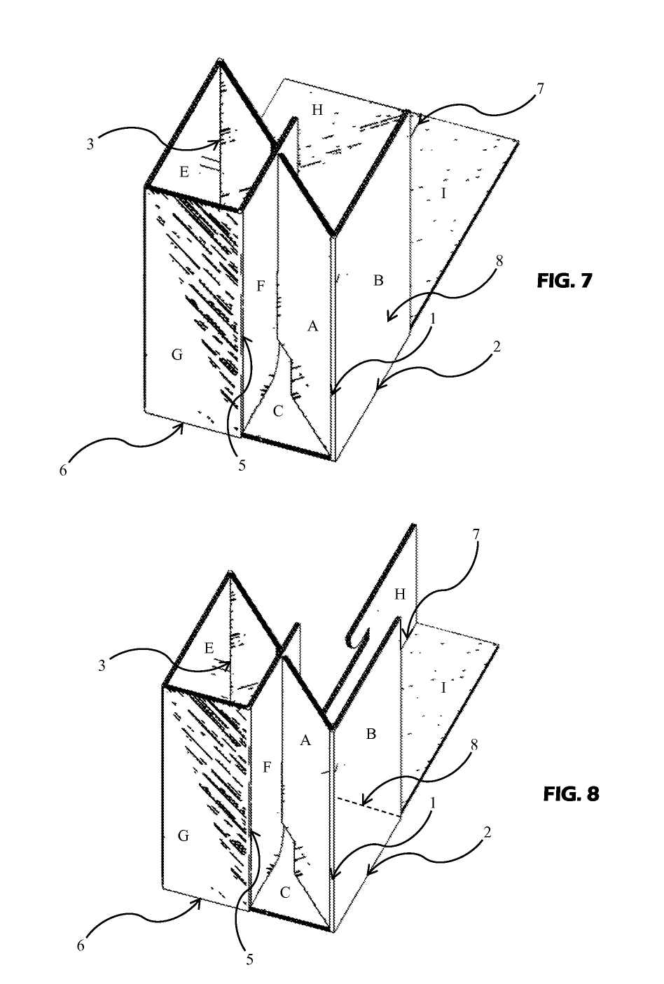

FIG. 7 shows an isometric view of the sixth step in assembly: Component G folded perpendicular along Axis 6 to Component C. Slot on Component F intersects the slots of Component A and Component D, hidden from view.

FIG. 8 shows an isometric view of the seventh step in assembly: Component H folded perpendicular along Axis 7 to Component I.

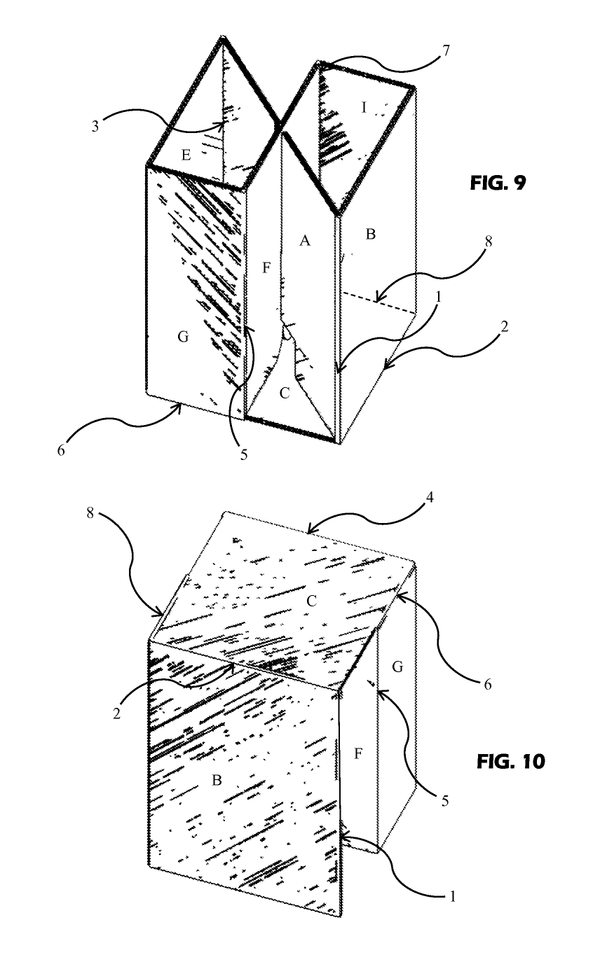

FIG. 9 shows an isometric view of the eighth step in assembly: Component I folded perpendicular along Axis 8 to Component C. Slot on Component H, hidden from view, intersects the slots of Component A and Component D, hidden from view. Component H, hidden from view, aligns parallel to Component F.

FIG. 10 shows an isometric view of apparatus with Component C appearing on the top.

We claim:

1. A single sheet of recyclable material precut, creased, and printed to serve as a temporary seating apparatus and refuse container, containing:
a) Exterior surfaces to be used as an advertising medium.
b) Two sides interlocking with two other sides, creating a crisscross shaped support structure.

2. A method of assembling and disassembling a seating apparatus and refuse container without the need for any tools or bonding agents, such as; glue, staples or other adhesives.

3. A seating apparatus, that when rotated upside down as seen in FIG. 9, becomes a refuse container for recyclable and/or non-recyclable materials.
